(19) United States
(12) Patent Application Publication
(10) Pub. No.: US 2014/0358617 A1
(43) Pub. Date: Dec. 4, 2014

(54) METHOD AND SYSTEM FOR PROJECT PLANNING AND ESTIMATION

(71) Applicant: François Lepage, St-Alfred (CA)

(72) Inventor: François Lepage, St-Alfred (CA)

(21) Appl. No.: 14/294,030

(22) Filed: Jun. 2, 2014

Related U.S. Application Data
(60) Provisional application No. 61/829,649, filed on May 31, 2013.

(51) Int. Cl. G06Q 10/06

(52) U.S. Cl. CPC G06Q 10/06313
USPC 705/7.23

(57) ABSTRACT

The present document describes a method for producing a construction plan, a corresponding list of materials and a corresponding cost estimate. The method comprises, at a computing device, receiving a selection of a type of construction project characterized by a predefined set of variables, an initial construction plan, a corresponding initial list of materials and a corresponding initial cost estimate. The method further comprises receiving a modification of at least one of the variables; and producing: an updated construction plan based on the variables; a corresponding updated list of materials based on the variables and on a list of unit materials; and a corresponding updated cost estimate based on the updated list of materials and on a list of unit prices for the list of unit materials

### CROSS-REFERENCE TO RELATED APPLICATIONS

This application claims priority of U.S. provisional patent application 61/829,649 filed May 31, 2013, the specification of which is hereby incorporated by reference.

### BACKGROUND

(a) Field

The subject matter disclosed generally relates to methods to design and to manage projects. More particularly, the subject matter disclosed relates to methods to design and to manage construction projects by producing construction project plans and cost estimates for the plan.

(b) Related Prior Art

Estimating the cost of a project is a central issue in the construction industry. The profitability of this industry relies among others on the ability to estimate the cost precisely. However, if one needs a precise estimation of the cost, this estimation may be time consuming and require substantial information on the prices of a large variety of items that have to be taken into account in this estimation.

Simple cost estimation methods may rely on simple rules comprising some calculations that are performed mentally. However, more comprehensive methods are implemented on software or computer-implemented applications and may include databases.

The items that have to be taken into account in a cost estimate comprise the material quantities, which depend on various geometrical calculations. Therefore, existing methods for cost estimation need many numerical inputs entered in the method by the user. It will be understood that the user needs to know these variables prior to the use of the method. Such numerical values may be gathered through the interpretation of a construction project plan. This interpretation may require professional experience with a construction project plan software or application.

The cost is estimated with databases comprising the cost of the various materials and services that are deemed necessary for the construction project.

Estimating the cost of a project is not the only purpose of the construction industry. For instance, buildings have to be designed before they are built and also before the cost is estimated. To design a building properly, one has to see a plan of the design. Thus, other useful methods for this industry include methods to create construction project plans.

If the user of such a method knows the dimensions and the shape of the building that is designed, the method to create a construction project plan is able to display a plan. This plan may be a 2D plan of the building (from above, from the front, from a side), a cross-section drawing or a 3D plan. In sophisticated methods, the 3D plan may be manipulated by the user.

To enable such a method to display a plan, all dimensions have to be known. If the user modifies dimensions, the displayed construction project plan is modified accordingly.

Existing methods for cost estimation are usually separate from methods for drawing and displaying construction project plans. In practice, it means the user needs more than one software or application product to perform these tasks. It also means the user has to interpret the construction project plan to gather all the information needed by the method for cost estimation. There is thus a need to produce construction project plans and cost estimate within the same method.

Should the construction project plan be modified, the entry of the building dimensions into prior art methods for cost estimation has to be done manually, which is fastidious and slows down the work. There is a need for a method providing the effect of a modification of a construction project plan on the cost estimate. There is also a need for a method that would quantify this effect in a very short period.

Existing methods do not display construction project plans and cost estimations at the same time, nor do they correct instantaneously the cost estimation when the construction project plan is modified. There is therefore a need for methods to produce construction project plans and cost estimates for the plan.

### SUMMARY

According to an embodiment, there is provided a method for producing a construction plan, a corresponding list of materials and a corresponding cost estimate, the method comprising:

at a computing device, receiving a selection of a type of construction project characterized by a predefined set of variables, an initial construction plan, a corresponding initial list of materials and a corresponding initial cost estimate;

at the computing device, receiving a modification of at least one of the variables; and

at the computing device, producing:
an updated construction plan based on the variables;
a corresponding updated list of materials based on the variables and on a list of unit materials; and
a corresponding updated cost estimate based on the corresponding updated list of materials and on a list of unit prices for the list of unit materials.

According to an aspect, the method further comprises sending, for presentation on a visual display, at least one of the updated construction plan, the corresponding updated list of materials and the corresponding updated cost estimate.

According to an aspect, sending, for presentation on a visual display, at least one of the updated construction plan, the corresponding updated list of materials and the corresponding updated cost estimate comprises sending the updated construction plan for the presentation of at least one of a cross-section view, a top view, and a three-dimensional view of the updated construction plan.

According to an aspect, obtaining a modification of at least one of the variables comprises obtaining at least one of an increase instruction and a decrease instruction for the at least one of the variables.

According to an aspect, obtaining a modification of at least one of the variables comprises updating, based on predefined rules, variables that are affected by the modification of the at least one of the variables.

According to an aspect, the method further comprises saving at least one of: the variables, the updated construction plan, the corresponding updated list of materials and the corresponding updated cost estimate.

According to an aspect, the method further comprises placing an order of materials corresponding at least in part to the corresponding updated list of materials.

According to an aspect, producing the construction plan and the corresponding cost estimate based on the variables is based on at least one of: a width of the construction project, a depth of the construction project, a height of the construction project, a number of levels of the construction project, and a type of materials used for the construction project.

According to an aspect, producing the construction plan and the corresponding cost estimate based on the list of unit materials is based on at least one of: a quantity of materials for a unit surface of wall, a quantity of materials for a unit surface of floor, and a quantity of materials for a unit volume of foundation.

According to an aspect, producing the construction plan and the corresponding cost estimate based on the list of unit prices is based on at least one of: a price of unit volume of wood, a price of unit volume of steel, a price of unit volume of concrete, and a price of a brick unit.

According to an aspect, producing a corresponding updated list of materials based on the variables and on a list of unit materials comprises producing an updated list of materials comprising a quantity for each material and a price per unit of material.

According to an embodiment, there is provided a user interface for producing a construction plan, a corresponding list of materials and a corresponding cost estimate for a construction project characterized by variables, the user interface comprising:

an input function for allowing a user to modify at least one of the variables; and

an output function for presenting at least two of the construction plan, the corresponding list of materials and the corresponding cost estimate,

wherein the user interface is for communication with a processing module which is for producing:
the construction plan based on the variables;
the corresponding list of materials based on the variables and on a list of unit materials; and
the corresponding cost estimate based on the corresponding list of materials and on a list of unit prices.

According to an aspect, the input function comprises at least one of a decreasing function for decreasing the at least one of the variables and an increasing function for increasing the at least one of the variables.

According to an aspect, the input function further comprises a material ordering function for allowing the user to place an order of materials appropriate for the construction project.

According to an embodiment, there is provided a system for producing a construction plan, a corresponding list of materials and a corresponding cost estimate for a construction project characterized by variables, the system comprising:

a processing device;

a memory for storing the variables, a list of unit materials and a list of unit prices for the list of unit materials;

a memory for storing instructions which cause the processing device:
to get a user modification of at least one of the variables; and
to produce the construction plan based on the variables, the corresponding list of materials based on the variables and on the list of unit materials, and the corresponding cost estimate based on the corresponding list of materials and on the list of unit prices; and
   a visual display for presenting at least one of the construction plan, the corresponding list of materials and the corresponding cost estimate,
      wherein the processing device, the memory and the visual display are in communication together.

According to an aspect, the variables comprise a type of construction project, a width of the construction project, a depth of the construction project, a height of the construction project, a number of levels of the construction project, and a type of materials used for the construction project.

According to an aspect, the list of unit materials comprises a quantity of materials for a unit surface of wall, a quantity of materials for a unit surface of floor, and a quantity of materials for a unit volume of foundation.

According to an aspect, the list of unit prices comprises a price of unit volume of wood, a price of unit volume of steel, a price of unit volume of concrete, and a price of a price of a brick unit.

According to an aspect, the system further comprises a communication network for connecting the visual display, the memory for storing instructions, the memory for storing the variables, a list of unit materials and a list of unit prices, and the processing device.

According to an aspect, the instructions comprise instructions which cause the processing device to get a user modification which comprises at least one of increasing and decreasing at least one of the variables.

### Definitions

Construction project: a project for building, renovating, expanding, demolishing or decorating a building, a room, a part of a building, a part of a room, a landscape element, a patio or any other project requiring construction abilities or materials.

Elements: walls, floors, ceilings, windows, doors and other physical parts that need to be put in place for the construction project.

Variables: the dimensions, number and/or location (if necessary) that characterize the elements.

Construction plan: graphical display of the construction project. The display includes 2D and 3D display, as well as top view, side view, cross-section view and other visualization means of the project.

Estimate: monetary evaluation of how much it will cost in materials and/or services to realize a project or a part of the project.

List of materials: includes not only an itemized list of materials per se, but also the material quantities (in units, weight, volume, dimensions) that are needed for the construction project. Unit prices (price per material quantity) can be provided along with the list of materials for each material.

### BRIEF DESCRIPTION OF THE DRAWINGS

Further features and advantages of the present disclosure will become apparent from the following detailed description, taken in combination with the appended drawings, in which:

FIG. 1 is a block diagram illustrating the overview of the logical operations that the method performs to transform the inputs of the method into output throughout decision-making in accordance with an embodiment;

FIG. 2 is a block diagram illustrating the calculations performed by the method in accordance with another embodiment;

FIG. 3 is a block diagram illustrating the computer system on which the method is implemented in accordance with another embodiment;

FIG. 4 is a screenshot illustrating the prompting of the user for a choice of an initial type of construction project in accordance with an embodiment;

FIG. 5 is a screenshot illustrating the prompting of the user for a more precise choice of the initial type of construction project that has been chosen by the user in accordance with an embodiment;

FIG. 6 is a screenshot illustrating the display by the method of the 3D plan and the cost estimate of the construction project, along with the menu of the variables that may be modified by the user in accordance with an embodiment;

FIG. 7 is a screenshot illustrating the display by the method of the updated 3D plan and the updated cost estimate of the construction project after one variable has been modified by the user by selecting the option desired by the user in accordance with an embodiment;

FIG. 8 is a screenshot illustrating the display by the method of the updated 3D plan and the updated cost estimate of the construction project after one variable has been modified by the user by increasing or decreasing a value in accordance with an embodiment;

FIG. 9 is a screenshot illustrating the display by the method of the 2D plan and the cost estimate of the construction project, with the same set of variables as in FIG. 8 in accordance with an embodiment;

FIG. 10 is a screenshot illustrating the display by the method of the updated 2D plan and the updated cost estimate of the construction project, after one variable (the roof slope) has been incremented by the user from the set of variables as in FIG. 8 in accordance with an embodiment;

FIG. 11 is a screenshot illustrating the display by the method of the cross-section drawing and its legend, with the same set of variables as in FIG. 8 in accordance with an embodiment;

FIG. 12 is a screenshot illustrating the display by the method of the updated cross-section drawing and its legend after one variable (the type of foundation) has been modified by a selection of the user from the set of variables as in FIG. 8 in accordance with an embodiment;

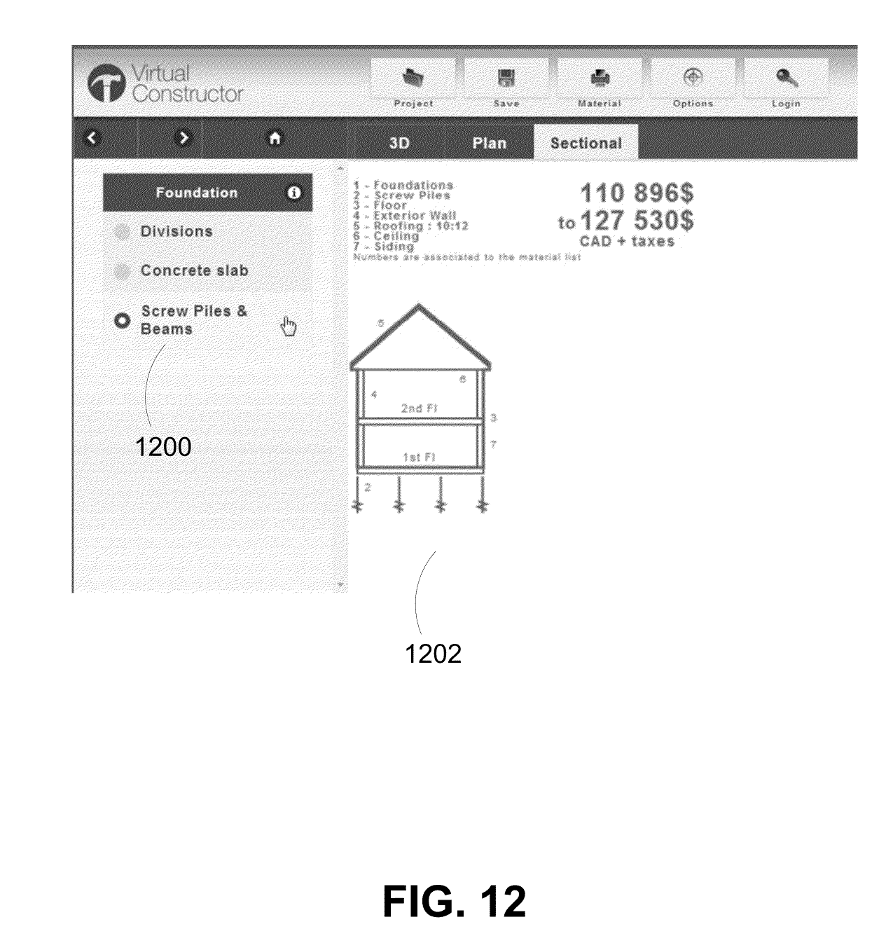

FIG. 13 is a screenshot illustrating the list of materials needed for the construction project in accordance with an embodiment; and

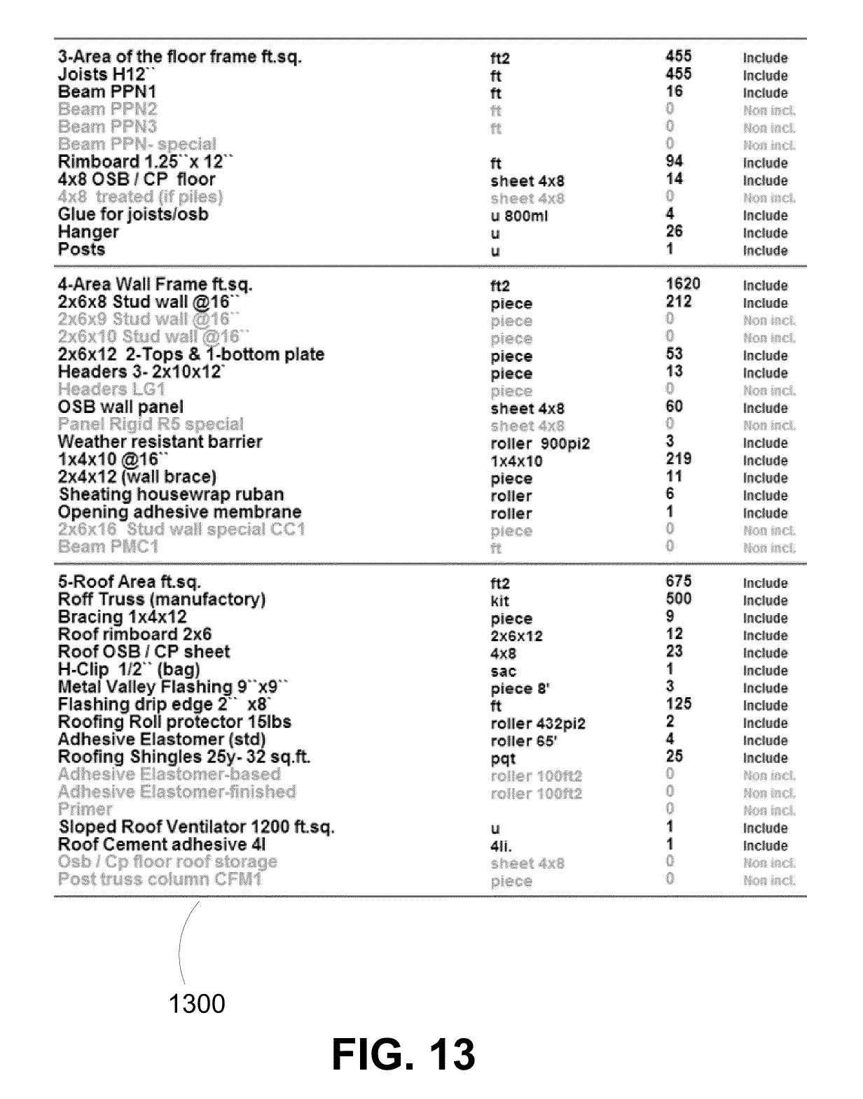

FIG. 14 is a screenshot illustrating the display by the method of the updated 3D plan and the updated cost estimate of the construction project after modification of the break size by the user in accordance with an embodiment.

It will be noted that throughout the appended drawings, like features are identified by like reference numerals.

### DETAILED DESCRIPTION

In embodiments described herein there are disclosed methods for simultaneous modification of a construction project plan and a cost estimate for the plan.

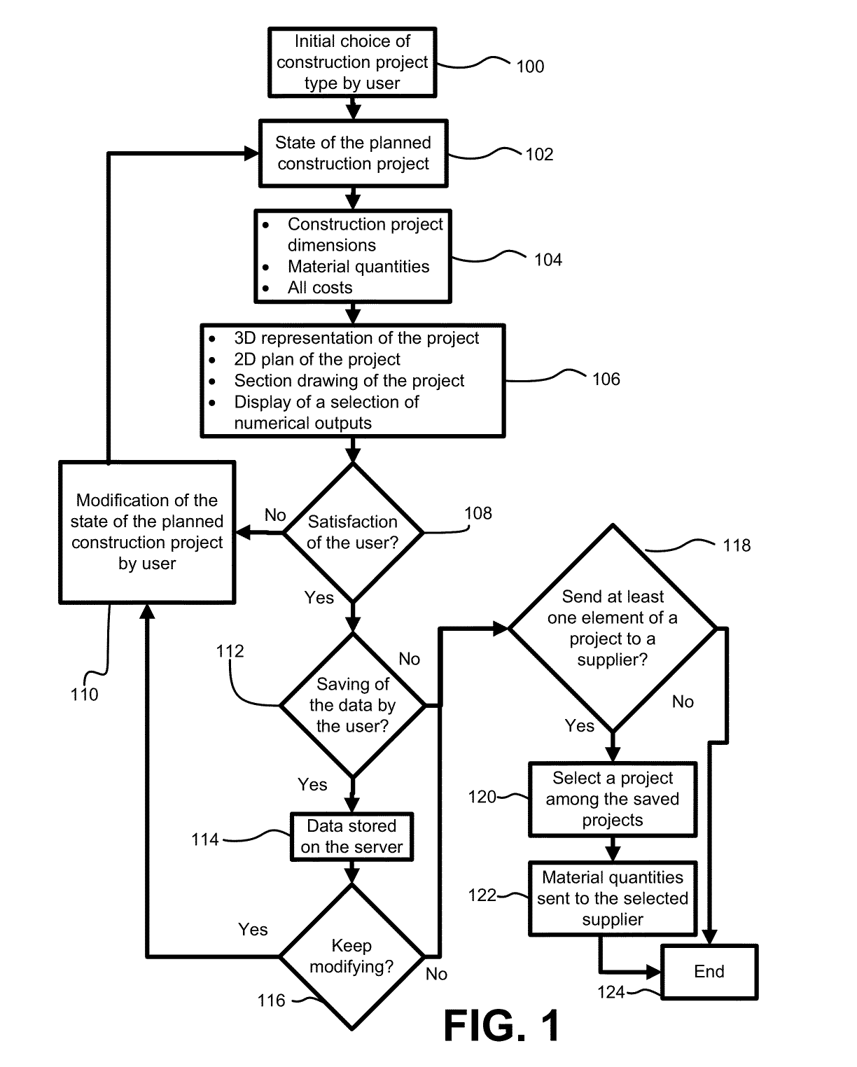

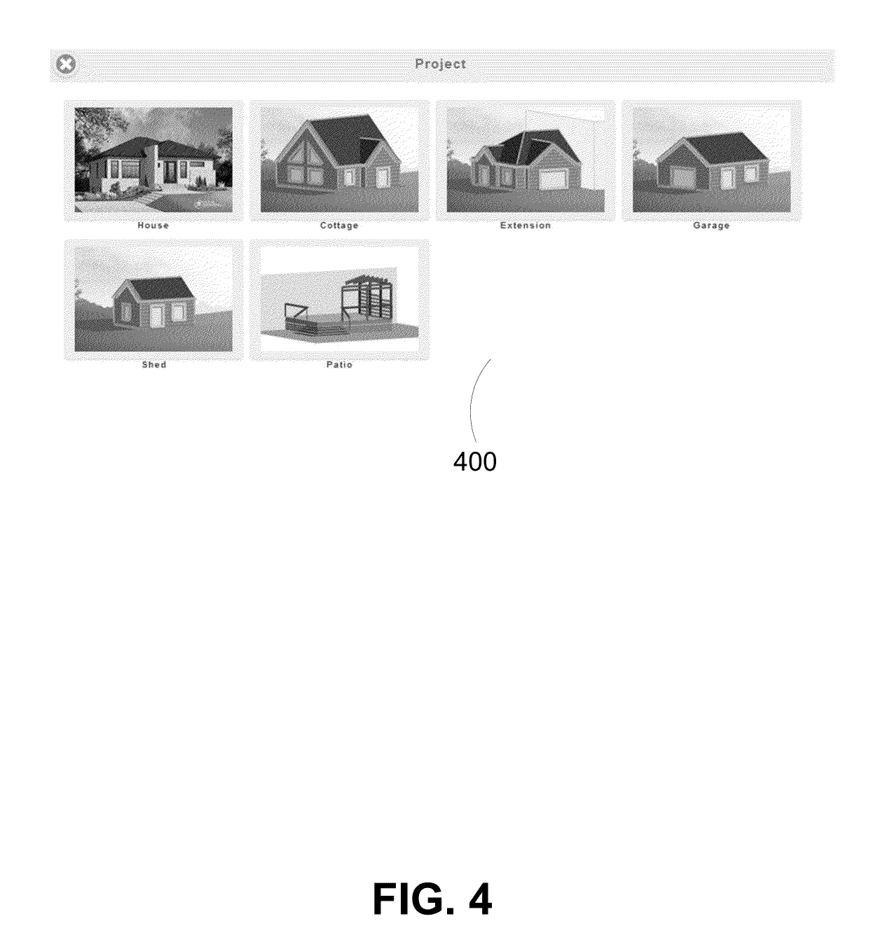

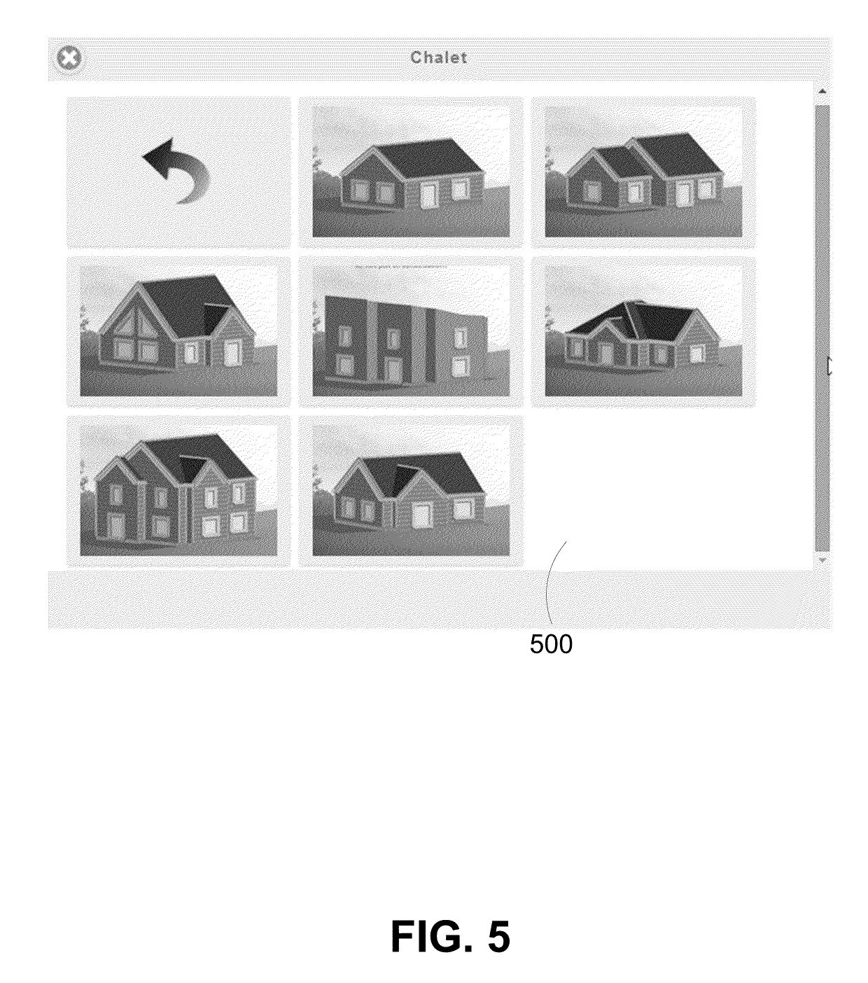

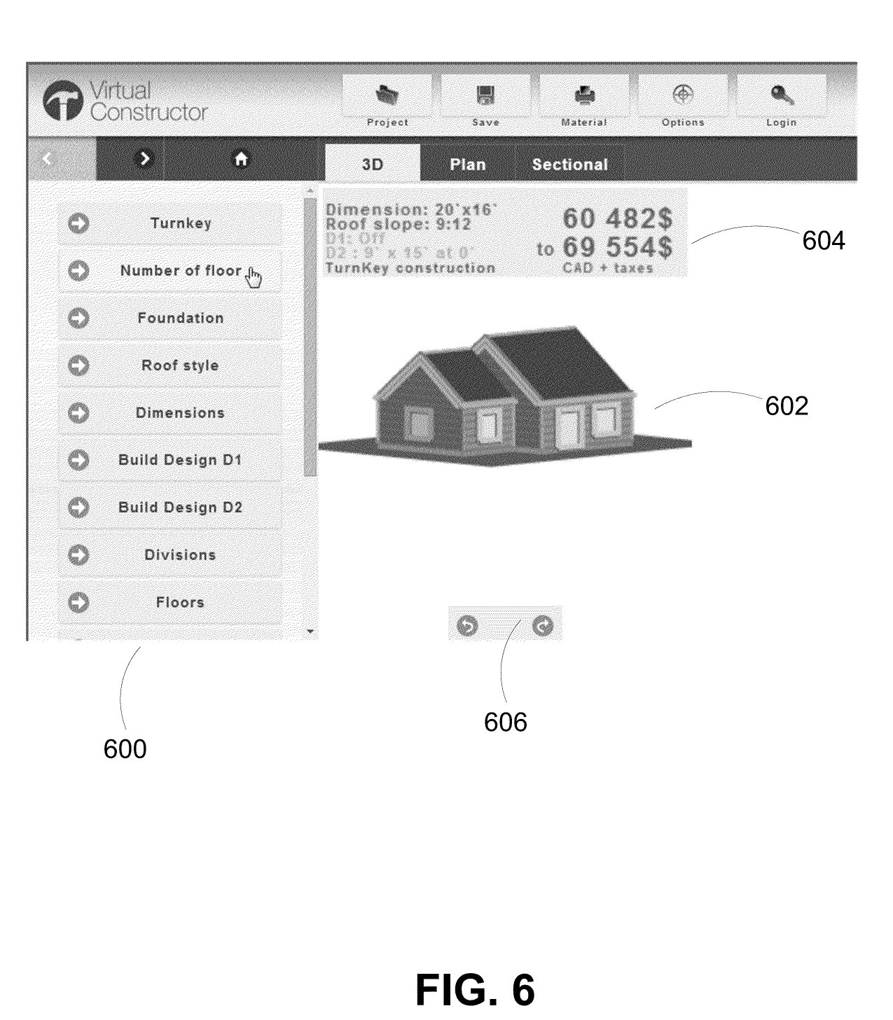

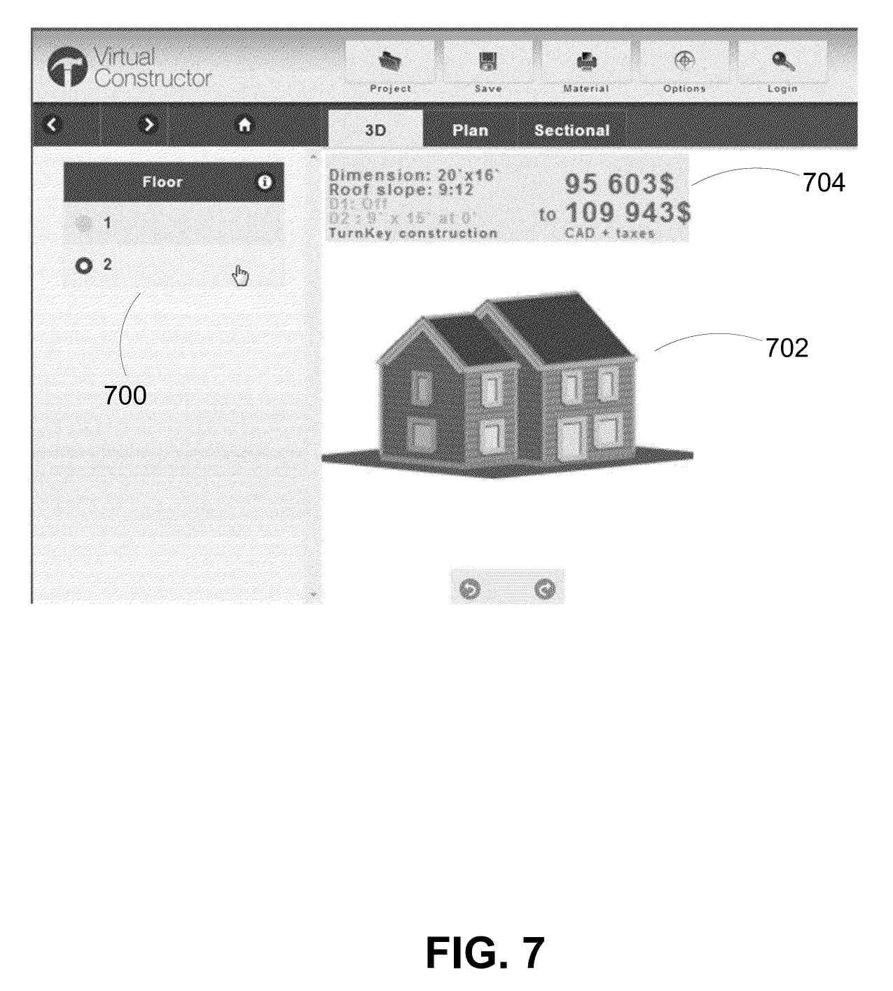

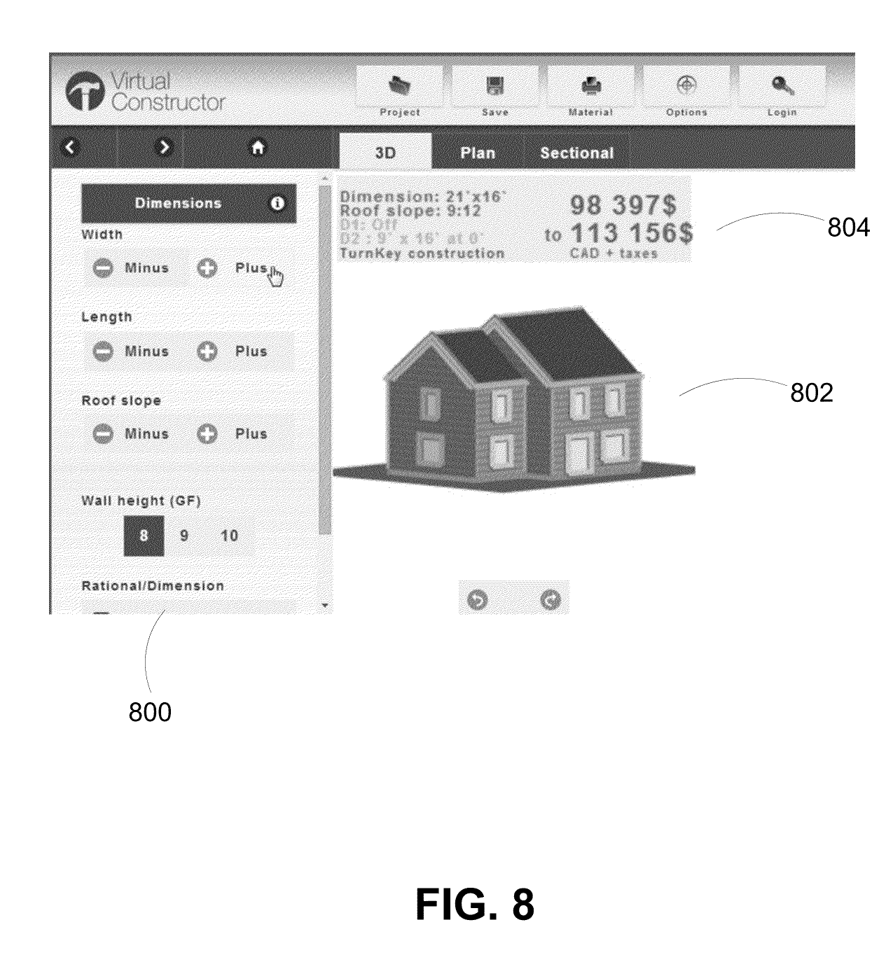

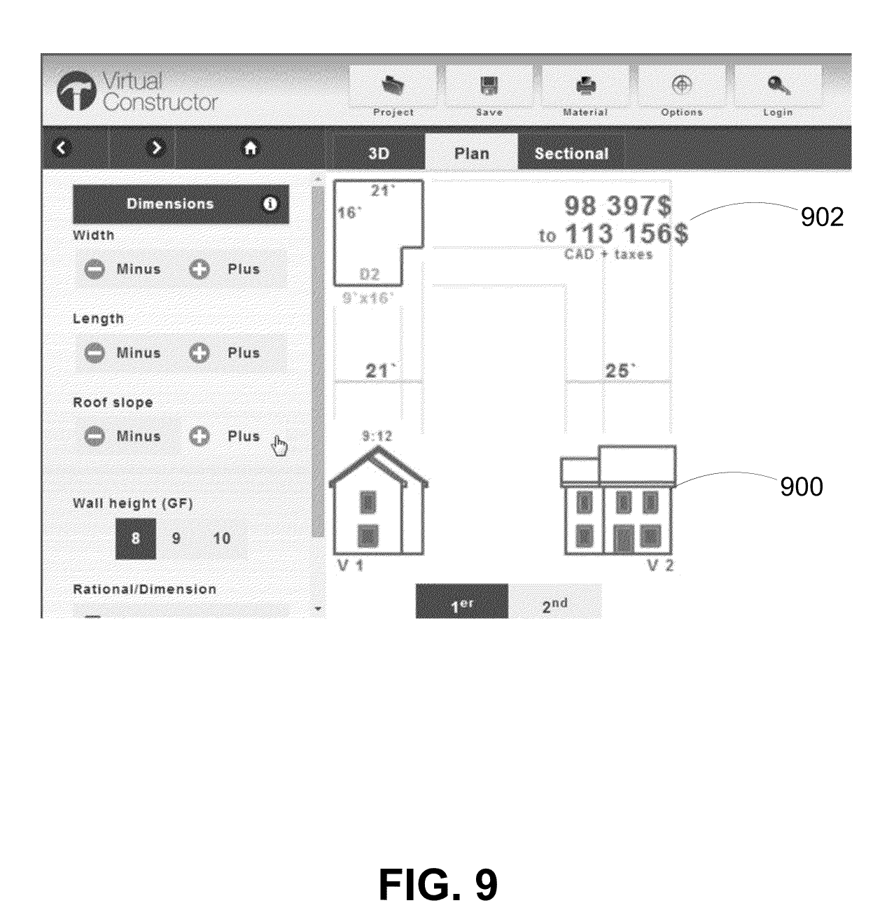

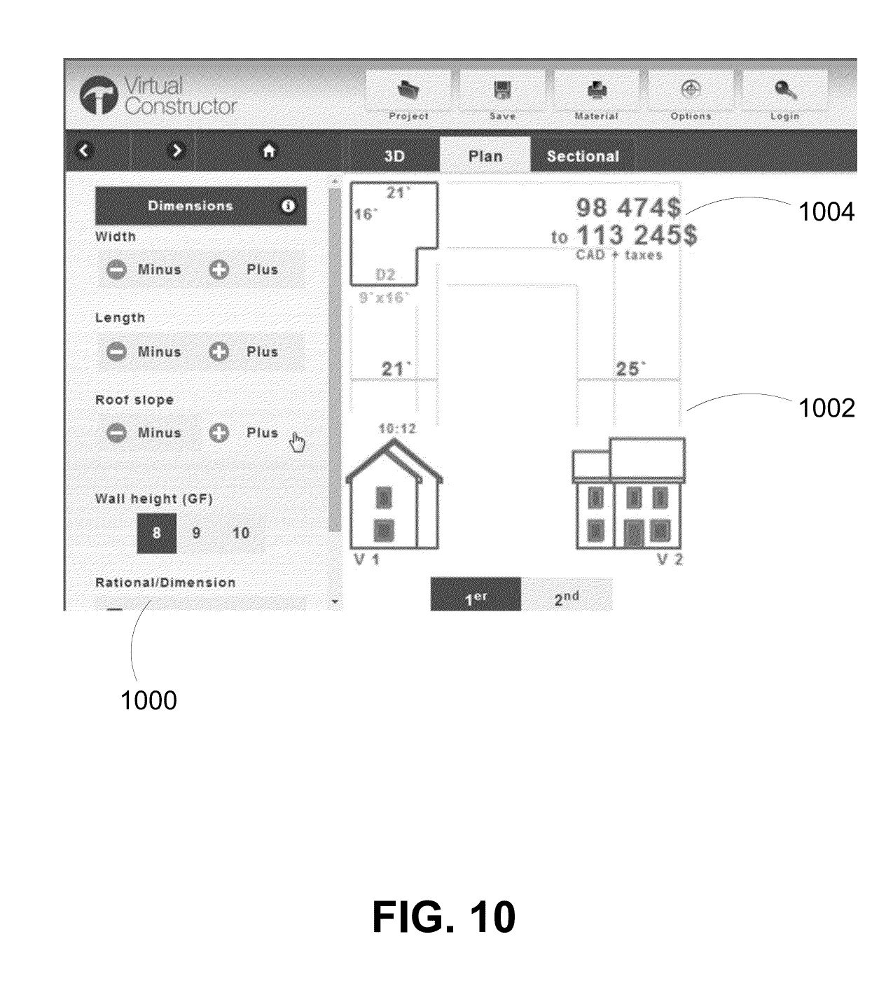

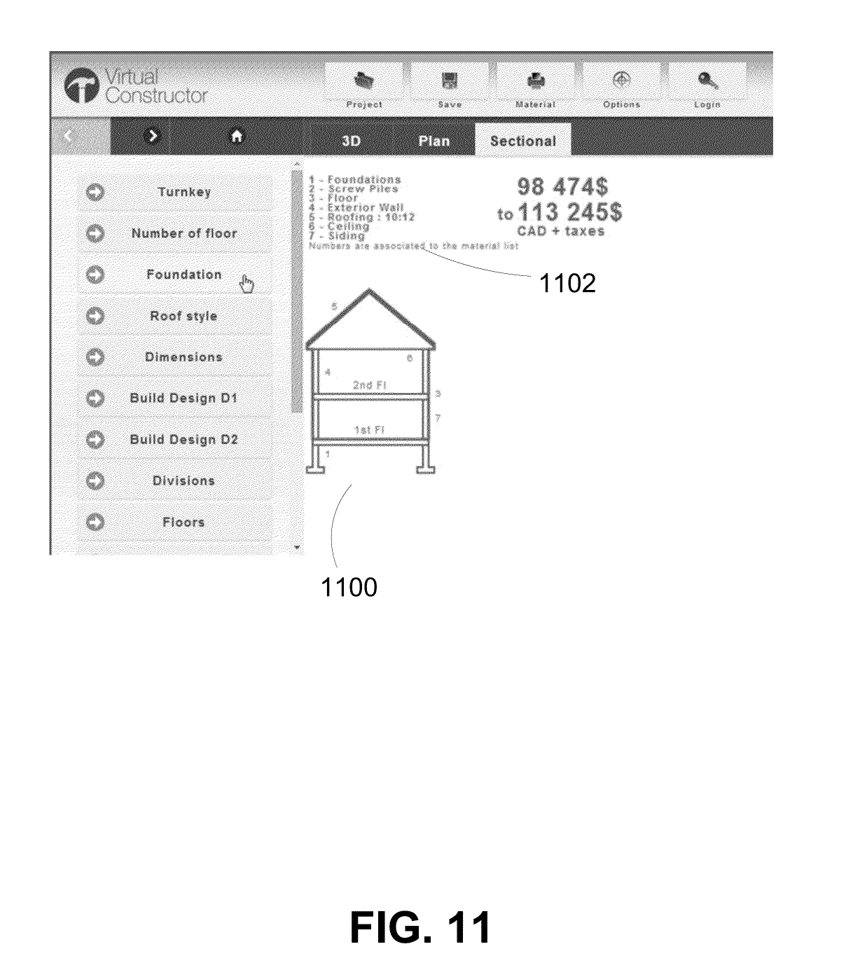

Referring now to the drawings, and more particularly to FIG. 1, a diagram illustrates an overview of how the user uses the method and how the method works from a logical perspective; and referring to FIGS. 4-11, screen captures of a software or application on which the method is implemented illustrate the user interface.

An initial choice of construction project type 100 made by the user is expected at the beginning of the method. More particularly, the user is prompted for a choice of a type of construction project by a prompt construction project type menu 400.

According to the physical support from which the method is used, the user may have to click or to touch a screen to select a type of building for which the method will produce a construction project plan and estimate costs. The type of construction project is displayed on the construction project type menu 400 and may include one of the following: house, garage, addition to an existing building, cottage, or garden shed. According to an embodiment, the construction project may also include renovation, decoration or demolition of a building or a room (such as: kitchen, bathroom, bedroom, living room, or commercial spaces), or for outdoor or landscape design projects (garden, backyard, patio, balcony, etc.). The type of construction project that is selected can also include an empty or virgin project, comprising nothing or only a few elements. This overly basic construction project can be modified and expanded thereafter. A customized construction project also be selected initially, either based on user preferences or on a previously designed and saved construction project.

According to an embodiment, the selection of the type of building may include a second construction project type menu 500 once the first choice is done by the user. This second construction project type menu 500 allows the user to select a shape for the building among various shapes displayed in the menu. The variables changing the shape are, for example, the number of floors, the presence of windows, number of breaks and a choice of widths and depths.

Once the user has selected the type of construction project, the state of the construction project 102 is defined by a set of variables. The set of variables that define the state of the building comprises, for example: the type of the building; the length, width and height of every room or wall; the number and position of windows, doors and garage doors; the roof slope; the number of floors; the presence of internal divisions on each floor; the type of foundation; the type of external envelope for the building; the color of the external envelope; the presence and the size of one or two breaks; the inclusion of construction or electricity in the cost estimation; the inclusion of the lighting, the air exchanger, the central vacuum or the chimney in the cost estimation; the inclusion of the lot, the septic tank, the artesian well, the disposal field and the blasting in the cost estimation; the inclusion of tool rental, container rental, scaffolding rental or concrete pump rental in the cost estimation; the inclusion of various permits, taxes, insurance, land surveying, bank fee and legal services in the cost estimation; the inclusion of costs related to the moving in the building in the cost estimation; and a viewing angle for the display of the 3D plan.

The method comprises instructions 104 that command various calculations to estimate the cost. These instructions comprise the calculation of the dimensions of various elements of the buildings, the calculation of the material quantities needed for the construction of this building through a list of unit materials and the cost estimate of the building and of various services through a list of unit prices of materials and services.

The method further comprises the display 106 of the cost estimate and plan. According to an embodiment, the plan comprises at least one of a 3D plan, 2D plan or cross-section drawing.

The method further comprises the display of the list 1300 of all the materials needed for the construction. In an embodiment, the materials of the list 1300 are highlighted if they are required in the construction project according to the plan, and they are not highlighted if they are not required.

According to an embodiment, this list may also include the quantity needed for each material to build the construction according to the construction project plan.

Then, the method waits for an action from the user according the satisfaction of the user 108. If the user is not satisfied, the user may modify a variable among the list of variables identified herein. These variables may be seen and modified by the user in the menu 600 of the user interface.

The modification 110 of at least one variable triggers the whole process of calculation and display of a plan, of a list of materials and of the cost estimate because the state of the construction project 102 is redefined. Therefore, a modification to the construction project plan produces an updated construction project plan along with an updated list of materials and an updated cost estimate. According to an embodiment, at least two of the construction project plan, the updated list of materials and the updated cost estimate are simultaneously produced and presented. The term “simultaneously” is intended to mean simultaneously from a human perspective. From the computer point of view, the construction project plan is produced before the cost estimate because computing the cost estimate is based on the construction project plan.

The method comprises the possibility for the user to select a button prompting the user for a saving 112 of the construction project, which comprises the construction project plan, the cost estimate and the material list, allowing data storage 114.

An additional opportunity for variable modification 116 is given after the data storage 114.

According to an embodiment, the method includes a sending menu 118 in which the user may select a supplier, the supplier being a store or a service provider, where the list could be sent electronically. If the user wants to send partially or completely a project, the project selection 120 has to be made. Then, the sending 122 to a supplier takes place.

When the users stops modifying the state of the construction project 102, or does not wish to save or send any more project, the method reaches the end 124.

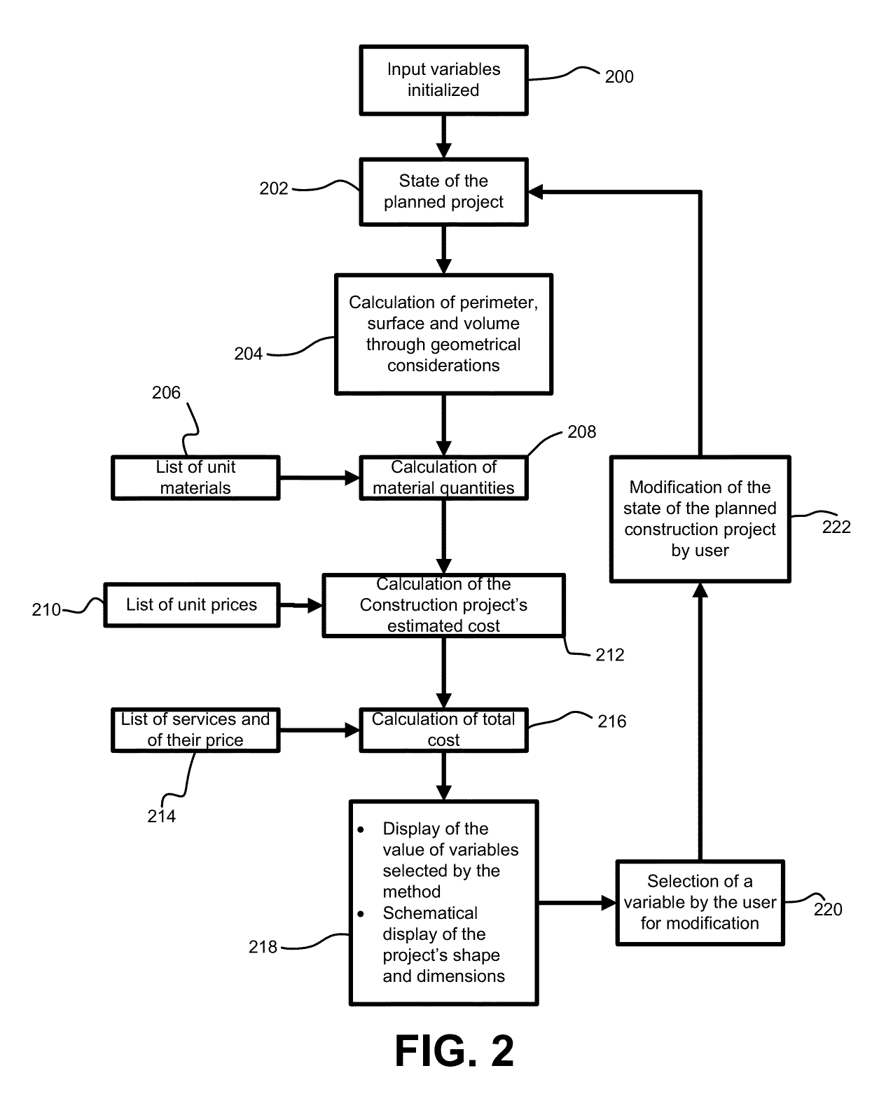

Now referring furthermore to FIG. 2, there is shown an embodiment of the order and the nature of the calculations performed by the method.

After the user has made the initial choices as described herein, all the input variables 200 are initialized to define the state of the construction project 202. The state therefore comprises an initial set of variables. Different types of construction projects are associated with variables that are set differently (for example if a user starts with a large house rather than with a small house), or may have sets of variables which do not define the same thing (for example, a house project will have variables that a patio project does not need to have, and vice versa).

According to an embodiment, when the user selects the first choice, only the type of construction project is selected and other variables are set with a default value (i.e. variables are predefined).

According to another embodiment, the user may select manually more than one variable for the initialization.

Once all variables have a value, the method is programmed to perform a series of calculations.

Through geometrical considerations, there is a calculation 204 of the perimeter, the area and the volume of major elements (such as walls or floors). Some constraints or rules can dictate the interrelation between variables. For example, these rules can define how much floor surface, or wall surface, is associated with given building dimensions. The rules can also dictate the interrelation such as the roof surface depending on the outer walls dimensions of the building, or the inner wall surface depending on the outer wall surface. Therefore, the rules define the passage between user-apparent variables (e.g. building dimensions) and non-apparent variables (such as inner wall surface).

Therefore, when the user is presented a type of construction project to choose, and when the type of construction project is chosen, a set of variables is initiated. This set of variables includes user-apparent variables and non-apparent variables. When the user modifies a variable (normally a user-apparent variable), the list of rules is used to modify the other variables (especially the non-apparent ones) accordingly.

Therefore, from simple variables such as building height, depth and length, roof type and inclination, location of windows, etc., other variables about various elements of the building such as perimeter, area and volume of each wall (outer and inner), floor, ceiling, roof, foundation, etc., can be deduced using the list of rules.

If the user is allowed to choose to expand the construction project by adding extensions, new rooms, a garage, etc., the new part of project created within the method triggers the generation of a new set of variables (both apparent and non-apparent) about this new part of the project. As for the main project, an initial state with an initial set of predefined variables can be associated with this extension.

The construction project for a building can include plans and estimates for a variety of rooms inside the building, or not, depending on the case. The plan and estimate can therefore apply to either a plain unfinished building, or a finished (and even furnished and decorated) building. The same concept applies to other types of construction projects.

The method comprises using a list of unit materials 206, which contains the quantity of materials needed for a unit perimeter, area or volume for the various elements of the building. For example, 1 m² of a basement floor could be the equivalent of a determined quantity of concrete, glue and wood boards.

The method performs the calculation 208 of each unit material using the appropriate characteristic (e.g., dimension or quantity of each element), which leads to the exact total material quantities for each type of material.

The method comprises using a list of unit prices 210, which contains the price for a unit length, area or volume or for one unit of a material.

The method performs the calculation 212 of each unit price using the appropriate material quantity, which leads to the cost estimate for the plain construction project.

The method comprises a list of services and their price 214. For every service that has been selected by the user, the price of the service is added to the cost estimate.

The total cost estimate 216 is displayed. On the user interface, it corresponds to the cost estimate display 604.

The method comprises a routine to draw a 3D plan, the routine using the type of building, the number of floors, the dimensions, the position of windows, doors, breaks and chimney, the roof slope and the angle of viewing to operate.

The method comprises a routine to draw a 2D plan from above and from one side of the building, the routine using the type of building, the number of floors, the dimensions, the position of windows, doors, breaks and chimney and the roof slope to operate.

The method comprises a routine to draw a cross-section drawing, the cross-section drawing comprising a lateral view of the building including the view of what is inside the building, the routine using the type of building, the number of floors, the dimensions, the position of windows, doors, breaks and chimney and the roof slope to operate.

According to another embodiment, at least one of the routine to draw a 3D plan, the routine to draw a 2D plan and the routine to draw a cross-section drawing, may require more or less variables whether they are designed to display respectively more or less detailed pictures of the construction project plan.

The method comprises a display 218 of at least one of the 3D plan, the 2D plan and the cross-section drawing on the user interface construction project plan display 602.

Once everything is displayed, the user is allowed to modify a variable. The variables that may be modified are all the variables stated herein. Length, width, roof slope and the viewing angle for the 3D plan display may be incremented or decremented by the user. All other variables are modified by checking, for example, a Boolean value (yes or no) or by selecting a choice among many available choices. The variable selection 220 is made in the menu 600 of the user interface, except for the viewing angle that is modified with the viewing angle button 606.

The modification 222 of one or more variables redefines the state of the planned building, which triggers the whole set of calculations performed in the method, leading to a new display of pictures and of the cost estimate. If variable 700 is modified by a new selection from the user, there is a 3D updated construction project plan display 702 and an updated cost estimate 704. If variable 800 such as length, width, break size or roof slope is incremented or decremented by the user, there is an updated 3D construction project plan display 802 and an updated cost estimate 804.

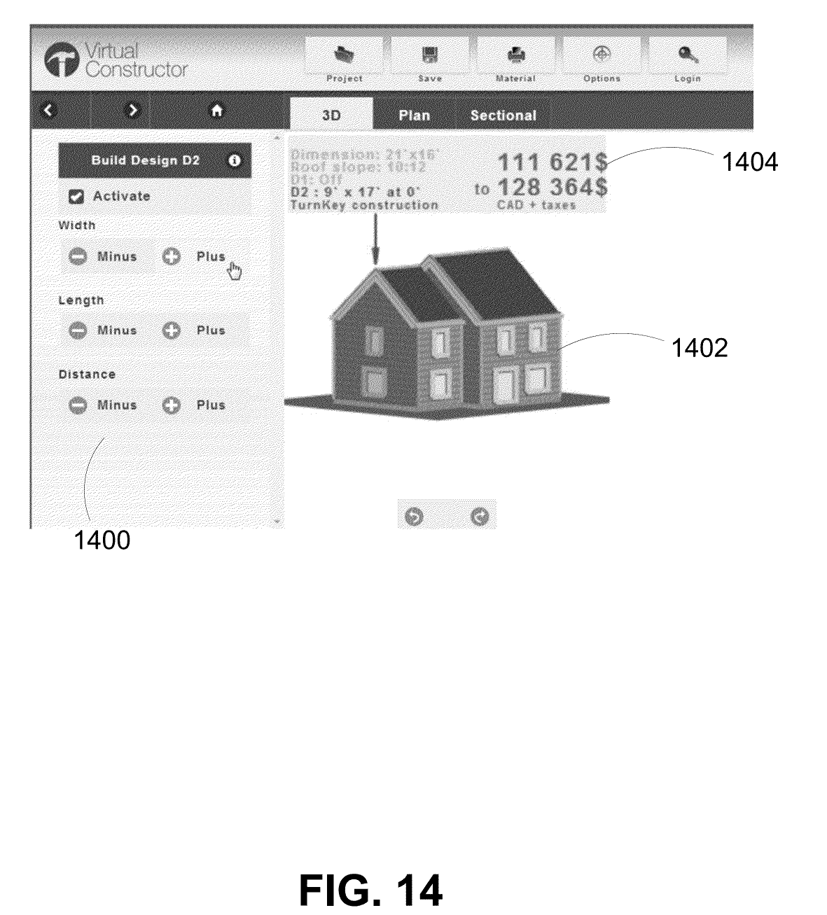

FIG. 14 shows an updated 3D display 1402 of the construction project plan and an updated cost estimate 1404 following the modification of the break size 1400.

If the user selects the 2D plan as a display option, the 2D construction project plan 900 is displayed, along with the cost estimate 902.

A modification of a variable, which may include, according to an embodiment, an increment or a decrement of a variable 1000, shows an updated 2D plan 1002, along with an updated cost estimate 1004.

If the user selects the cross-section drawing as a display option, the cross-section drawing 1100 of the construction project plan is displayed, along with the legend 1102.

A modification of a variable, which may be, according to an embodiment, a selection of a variable 1200 (for example the foundation type, which has been changed from a concrete fill to piling and beams, and could have been a concrete wall or just no foundation) among a choice of many values for the variable, shows an updated 2D plan 1202.

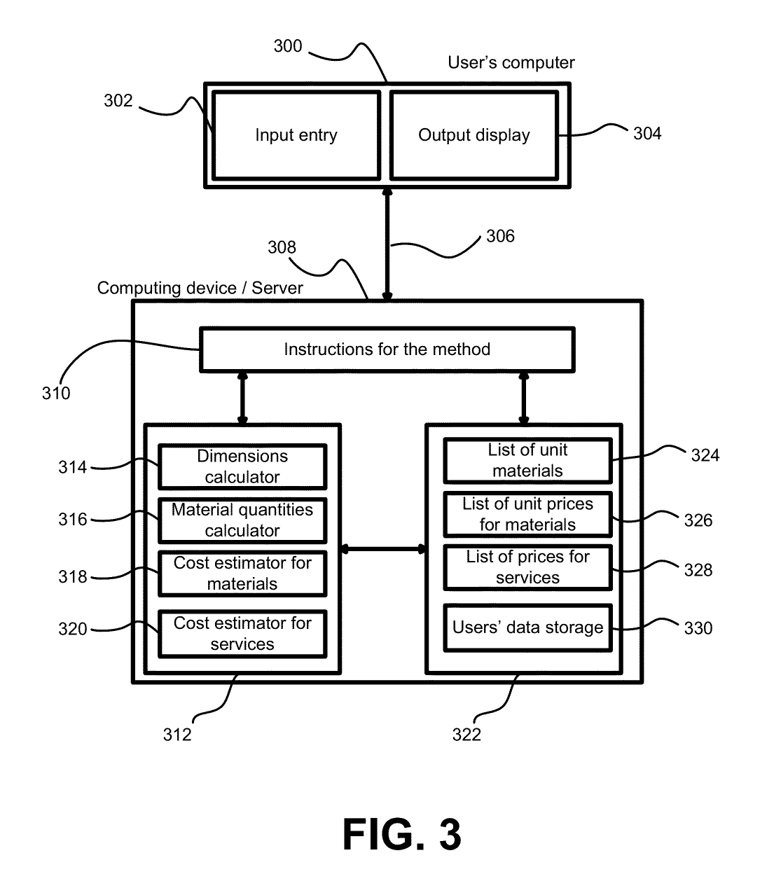

Now referring to FIG. 3, there is shown an embodiment of the computer system on which the method is implemented.

The user needs a computer to use the method. The user's computer 300 may be a tabletop computer, a laptop computer, a smartphone or any device with a display and an access to a connection 306. The connection 306 can be a communication network such as the internet, cabled communication or an electric connection to another part of the user's computer 300. Using this computer 300 through the connection 306, the user is able to open the software or application on which the method described herein is implemented. According to another embodiment, the user uses the method through an interactive terminal or kiosk provided at the merchant facility. Alternatively, an employee at the merchant facility can receive and review a saved construction project plan and estimate that was sent by the user through a communication network.

The user's computer 300 serves as a physical interface between the user and the method and has two functions. The first one is the user data entry function 302 allowed by the clicking on selected choices on the screen. The second function is the display of the output 304 of the method on the screen, so the user can see the result of the method.

According to an embodiment, the processing capabilities and the memories (comprising the method's instructions and all data) are both located on the same device, such as the user's computer 300, which also comprises a display. According to another embodiment, the user's computer 300 needs a connection 306 taking the form of a communication network to perform the method, the instructions for the method being stored on a remote or external server 308. In this case, both the instructions and data are stored remotely from the user's computer 300, which serves for input and output of data. The connection can be wireless or cabled. According to another embodiment, an application can be downloaded directly on the user's computer 300 for performing the instructions, but uses data stored on the external server 308 or elsewhere. Therefore, the instructions, data and processing capabilities can be either localized (at a local or remote place) or delocalized (the method is performed at various locations). In this case, the server 308 is a computing or processing device within the computer.

The external server 308 and the user's computer 300 are computers used to store the instructions of the method 310, to perform the calculations 312 used in the method and to store the project of a user, the lists and the databases necessary for the calculations in memory 322. As mentioned above, the external server 308 and the user's computer 300 can be separate devices or be the same device.

According to another embodiment, at least one of the instructions 310, lists, databases and users' projects stored in memory 322 are stored on a separate device that can be connected to the external server 308.

The instructions 310 are written in a programming language readable by a compiler installed on the external server 308. Some instructions are made to the processor of the external server 308 to perform calculations related to dimensions 314 (perimeters, areas and volumes of various elements in the building), calculations related to materials 316 (number, length, surface or volume), calculations related to costs for materials 318 and calculations related to cost for services 320. Some instructions are made to the processor to command the display of the shape of the building, of the legend for the display and on the cost.

The instructions also retrieve data that is stored in databases for use in the calculations. The databases comprise a list of unit materials 324, a list of unit prices for materials 326, a list of services and of their price 328 and the users' data storage system 330.

According to an embodiment, the method is implemented in an interface for producing a construction project plan and a corresponding cost estimate. The interface comprises an input function for allowing a user to modify at least one of the variables. According to an embodiment, this modification includes an increasing function and a decreasing function for respectively increasing and decreasing a given variable. Other modifications to variables can be performed by checking the appropriate option between various choices.

The interface further comprises a processing module, which is the part of the interface producing the construction project plan and the corresponding cost estimate based on the variables, i.e. the part that performs calculations.

The interface further comprises an output function for presenting the construction project plan and the corresponding cost estimate to the user, or for outputting the results to another application.

According to an embodiment, an ordering function can be included in the interface to allow the user to place an order to a supplier, such as a hardware store, a general or specialized contractor. The user can be actively prompted (i.e. a dialog box appears) to agree or disagree about placing an order. Alternatively, the interface through which the user uses the method can comprise a permanent panel or dialog box in which the user can place an order. According to an embodiment, placing an order comprises sending the list of materials to the merchant facility (supplier), for example through a communication network. Sending the list of materials to that supplier allows the supplier to validate the availability or prices of the ordered materials, to perform a technical review of the project by an employee of that facility, or to invoice. Alternatively, placing an order allows the user to buy online the materials (or a part of the materials) that are needed to realize the construction project.

According to an embodiment, the method is implemented in a computing system. The system comprises a visual display, such as a computer, phone, tablet or other electronic device having a display function. The visual display allows the user to see the options to choose, or the variables that can be increased or decreased. The user can also see the results such as construction project plan and the cost estimate that corresponds to the plan.

The calculations and logical operations that are needed to produce the construction project plan and the cost estimate are performed within a processing or computing device (such as a computer processor). The processing or computing device may be in the same machine as the visual display, or may be remote, for example in a remote or external server connected to the visual display through a communication network (e.g. the internet).

The operations performed by the processing device are in accordance with instructions, which are stored on a memory. All variables and data (list of unit materials, list of prices and any other lists) are also stored on a memory, which can be the same memory as the memory for instructions, or a separate one. The memory or memories can be in the same machine as the visual display (the user's computer 300), or in the same machine as the processing device (such as in a remote server), or in a separate device (flash memory, CD-rom, external drive, another remote server or any other type of external memory).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for producing a construction plan, a corresponding list of materials and a corresponding cost estimate, the method comprising:
at a computing device, receiving a selection of a type of construction project characterized by a predefined set of variables, an initial construction plan, a corresponding initial list of materials and a corresponding initial cost estimate;
at the computing device, receiving a modification of at least one of the variables; and
at the computing device, producing:
an updated construction plan based on the variables;
a corresponding updated list of materials based on the variables and on a list of unit materials; and
a corresponding updated cost estimate based on the corresponding updated list of materials and on a list of unit prices for the list of unit materials.

2. The method of claim 1, further comprising sending, for presentation on a visual display, at least one of the updated construction plan, the corresponding updated list of materials and the corresponding updated cost estimate.

3. The method of claim 2, wherein sending, for presentation on a visual display, at least one of the updated construction plan, the corresponding updated list of materials and the corresponding updated cost estimate comprises sending the updated construction plan for the presentation of at least one of a cross-section view, a top view, and a three-dimensional view of the updated construction plan.

4. The method of claim 1, wherein obtaining a modification of at least one of the variables comprises obtaining at least one of an increase instruction and a decrease instruction for the at least one of the variables.

5. The method of claim 1, wherein obtaining a modification of at least one of the variables comprises updating, based on predefined rules, variables that are affected by the modification of the at least one of the variables.

6. The method of claim 1, further comprising saving at least one of: the variables, the updated construction plan, the corresponding updated list of materials and the corresponding updated cost estimate.

7. The method of claim 1, further comprising placing an order of materials corresponding at least in part to the corresponding updated list of materials.

8. The method of claim 1, wherein producing the construction plan and the corresponding cost estimate based on the variables is based on at least one of: a width of the construction project, a depth of the construction project, a height of the construction project, a number of levels of the construction project, and a type of materials used for the construction project.

9. The method of claim 1, wherein producing the construction plan and the corresponding cost estimate based on the list of unit materials is based on at least one of: a quantity of materials for a unit surface of wall, a quantity of materials for a unit surface of floor, and a quantity of materials for a unit volume of foundation.

10. The method of claim 1, wherein producing the construction plan and the corresponding cost estimate based on the list of unit prices is based on at least one of: a price of unit volume of wood, a price of unit volume of steel, a price of unit volume of concrete, and a price of a brick unit.

11. The method of claim 1, wherein the producing a corresponding updated list of materials based on the variables and on a list of unit materials comprises producing an updated list of materials comprising a quantity for each material and a price per unit of material.

12. A user interface for producing a construction plan, a corresponding list of materials and a corresponding cost estimate for a construction project characterized by variables, the user interface comprising:
an input function for allowing a user to modify at least one of the variables; and
an output function for presenting at least two of the construction plan, the corresponding list of materials and the corresponding cost estimate,
wherein the user interface is for communication with a processing module which is for producing:
the construction plan based on the variables;
the corresponding list of materials based on the variables and on a list of unit materials; and
the corresponding cost estimate based on the corresponding list of materials and on a list of unit prices.

13. The user interface of claim 12, wherein the input function comprises at least one of a decreasing function for decreasing the at least one of the variables and an increasing function for increasing the at least one of the variables.

14. The user interface of claim 12, wherein the input function further comprises a material ordering function for allowing the user to place an order of materials appropriate for the construction project.

15. A system for producing a construction plan, a corresponding list of materials and a corresponding cost estimate for a construction project characterized by variables, the system comprising:
a processing device;
a memory for storing the variables, a list of unit materials and a list of unit prices for the list of unit materials;
a memory for storing instructions which cause the processing device:
to get a user modification of at least one of the variables; and
to produce the construction plan based on the variables, the corresponding list of materials based on the variables and on the list of unit materials, and the corresponding cost estimate based on the corresponding list of materials and on the list of unit prices; and
a visual display for presenting at least one of the construction plan, the corresponding list of materials and the corresponding cost estimate,
wherein the processing device, the memory and the visual display are in communication together.

16. The system of claim 15, wherein the variables comprise a type of construction project, a width of the construction project, a depth of the construction project, a height of the construction project, a number of levels of the construction project, and a type of materials used for the construction project.

17. The system of claim 15, wherein the list of unit materials comprises a quantity of materials for a unit surface of wall, a quantity of materials for a unit surface of floor, and a quantity of materials for a unit volume of foundation.

18. The system of claim 15, wherein the list of unit prices comprises a price of unit volume of wood, a price of unit volume of steel, a price of unit volume of concrete, and a price of a price of a brick unit.

19. The system of claim 15, further comprising a communication network for connecting the visual display, the memory for storing instructions, the memory for storing the variables, a list of unit materials and a list of unit prices, and the processing device.

20. The system of claim 15, wherein the instructions comprise instructions which cause the processing device to get a user modification which comprises at least one of increasing and decreasing at least one of the variables.
